(19) United States
(12) Patent Application Publication
(10) Pub. No.: US 2008/0299529 A1
(43) Pub. Date: Dec. 4, 2008

(54) Training Model for the Endoscopic Investigation and Treatment of Hollow Organs

(76) Inventor: Daniel Schaller, Tubingen (DE)

Correspondence Address: DICKSTEIN SHAPIRO LLP, 1825 EYE STREET NW, Washington, DC, 20006-5403, US

(21) Appl. No.: 12/097,459

(22) PCT Filed: Nov. 30, 2006
(86) PCT No.: PCT/EP2006/011509

§ 371 Date: Aug. 13, 2008

(30) Foreign Application Priority Data
Dec. 13, 2005 (DE) 10 2005 059 559.6
Jan. 19, 2006 (DE) 10 2006 002 707.8

(51) Int. Cl. G09B 23/30

(52) U.S. Cl. 434/267

(57) ABSTRACT

A training model for endoscopic investigation and the treatment of hollow organs. The training model includes a chamber intended for accommodating the hollow organ with a chamber wall, at least one inlet fastened in the chamber wall with a coupling device to which the hollow organ can be coupled for the introduction of an endoscope through the inlet into the hollow organ, a connection in the chamber wall to which can be coupled a suction pump for the generation of a negative pressure in the chamber and a moulding in the chamber comprising a cavity into which the coupling device opens out and which is adapted to an outer contour of the hollow organ and into which the hollow organ can be inserted. The generation of a negative pressure allows the hollow organ to be widened in accordance with natural conditions.

### DESCRIPTION

The invention relates to a training model for endoscopic investigations and the treatment of hollow organs.

### BACKGROUND OF THE INVENTION

For the demonstration of or training in therapeutic procedures such as high-frequency (“HF”) surgery, cryosurgery, laser or microwave treatment and for endoscopic procedures or procedures using laparascopes, replicas of the human organs to be investigated or treated are provided. These replicas themselves frequently comprise animal substitute tissue. Replicas are also provided for diagnostic procedures. One of the most realistic replica organs is the relevant organ from an animal similar to humans, the pig.

For endoscopic procedures, generally hollow organs are used which are fixed in a suitable fashion in order to satisfy the requirements levied on the training or the demonstration. Requirements include certain optical properties, such as, for example, good visibility inside the hollow organ and its colour and also certain mechanical properties such as the hardness and elasticity of the wall of the hollow organ. The moisture content of the hollow organ wall also plays a significant role.

If a thin-walled animal hollow organ is used, without the use of additional supportive measures, the organ will collapse so that free visibility through the endoscope/laparascope is not guaranteed. A collapsed organ naturally does not conform to the actual conditions of a hollow organ within an animal.

In addition, for the simulation of tissue areas requiring therapy, such as, for example, tumours, polyps or similar tissue changes, it is necessary to introduce corresponding “foreign bodies” to represent the tumours, polyps or similar tissue areas. These foreign bodies can comprise biological or even synthetic material, but must also have the natural functions and characteristics of the tissues. For example, in the case of HF-surgical procedures, the foreign bodies must be electrically conductive. After the end of the “therapy”, these foreign bodies are unusable and are replaced. Therefore, for effective work, the fastest possible replacement is necessary.

Known from US 2000/0008997 A1 is a portable training and research model which demonstrates sections of the lower and upper gastrointestinal tract by the insertion of part-segments (including those of animal origin) into a supporting surface. The part-segments to be inserted are fixed by a net. The insertion of the hollow organ to be treated is extremely complicated and the apparatus as a whole is also very complicated.

The invention is based on the object of disclosing a training model of the type described in such a way that it is possible in a simple way to create a situation as similar as possible to the natural situation for the trainer or for the student.

The object is achieved by a training model for endoscopic investigations and treatment of hollow organs comprising
a chamber for accommodating the hollow organ with a chamber wall, at least one inlet which is fastened in the chamber wall with a coupling device to which the hollow organ can be coupled for introducing an endoscope through the inlet into the hollow organ, a connection in the chamber wall to which can be coupled a suction pump for the generation of a negative pressure in the chamber and a moulding in the chamber comprising a cavity into which the coupling device opens out and which is adapted to an outer contour of the hollow organ and into which the hollow organ can be inserted.

An essential point of the invention consists in the fact that, on the one hand, a shape is specified which is intended to comprise the hollow organ to be investigated or treated and, on the other, the hollow organ is pressed by a negative pressure in the chamber relative to a normal pressure in the interior of the hollow organ against the wall of the hollow body. If the vacuum or suction pump has a sufficient capacity, even in the case of some leakage, it is possible to ensure adequate stability of the hollow organ to be investigated in the training model.

To be able to provide training for operations, preferably a quick-change device is provided comprising a connecting section for connecting the hollow organ to the quick-change device and an interchangeable section for the interchangeable mounting of a treatment body inside the hollow organ. Therefore, the hollow organ is only used as a multi-use “environment”, while the treatment body, which is treated for example with HF-surgical methods for excision, can be easily replaced after each attempt.

Preferably, in this case the quick-change device is attached traversing the chamber wall so that the treatment body can be replaced from the outside.

The moulding preferably substantially fills the chamber so that no complex holding structures are required. It is hereby of great advantage if the moulding is made of a porous material, for example, foam, so that the evacuation of air by a corresponding negative pressure in the region of the recess for accommodating the hollow organ is ensured.

For the simple insertion of a hollow organ, the moulding can preferably be divided along a centre plane leading through the cavity at least in sections. The hollow organ can then be inserted in a still collapsed condition upon which the chamber is closed and hence the cavity established. On the evacuation of air, the inserted hollow organ then lies on the inside wall of the cavity and obtains its shape replicating the natural conditions as realistically as possible.

The inlet preferably comprises a support device for supporting an endoscope for introduction into the hollow organ. This also corresponds to the normal situation in which an endoscope is introduced either through the mouth or the sphincter and can be supported there. Preferably, the support device comprises an expandable opening with a smaller diameter than the hollow organ, preferably a smaller diameter than the endoscope to be used. This again corresponds to the natural conditions found during an actual operation.

The quick-change device comprises a preferably interchangeable diaphragm to which the treatment body can be fixed. This embodiment best reproduces natural conditions. In addition, it is possible to provide a plurality of such diaphragms with treatment bodies attached thereto which can then be inserted in the quick-change device as required.

Preferably, the quick-change device comprises a clip, a hook, a pointed bar, a screw or a similar fastening means in order to fasten the treatment body to the diaphragm in an easily replaceable manner.

In a preferred embodiment of the invention, the quick-change device comprises an external bushing which is fastened in the chamber wall. The interchangeable section can be inserted into the bushing, wherein a seal (for example an O-ring) ensures that it is secured in a frictionally locking manner.

The quick-change device and/or the coupling device is preferably embodied as electrically conductive and provided with a connection for connection to a neutral electrode of an HF-surgical device. This enables HF-surgical methods to be performed very simply in accordance with natural conditions since the hollow organ is electrically conductive due to its inherent moisture. To maintain this condition, that is to maintain the natural water content, preferably a wettable layer is provided disposed between the hollow organ and the moulding. The moulding itself can also take the place of the wetted layer.

In order to evacuate the vapours or smoke that form during HF-surgical procedures (for example argon-plasma coagulation), preferably a smoke evacuation device is provided. This can in particular be attached to the coupling device or to the quick-change device so that no separate coupling of the hollow organ or its interior to the smoke evacuation device is necessary.

### BRIEF DESCRIPTION OF THE DRAWINGS

Preferred embodiments of the invention may be derived from the following exemplary embodiments which will be explained in further detail with reference to the figures.

FIG. 1 is a cross section through a first embodiment of a chamber with an inserted hollow organ and connections.

FIG. 2 is a section along the line II-II in FIG. 1.

FIG. 3 is a further embodiment of the invention with an another inserted hollow organ.

FIG. 4 is a partial section through an embodiment of the invention to explain the shaping properties of the cavity.

FIG. 5 is a cross section through a quick-change device.

FIG. 6 is a perspective view of a part of the quick-change device in FIG. 5.

FIG. 7 is a further embodiment of a quick-change device with a smoke evacuation device.

FIG. 8 is a view of the device according to FIG. 7 along the line VIII-VIII.

FIG. 9 is a partial longitudinal section through an inlet.

FIG. 10 is a view along the line X-X in FIG. 9.

### DETAILED DESCRIPTION OF THE INVENTION

In the following description, the same reference numbers are used for identical parts and parts with an identical function.

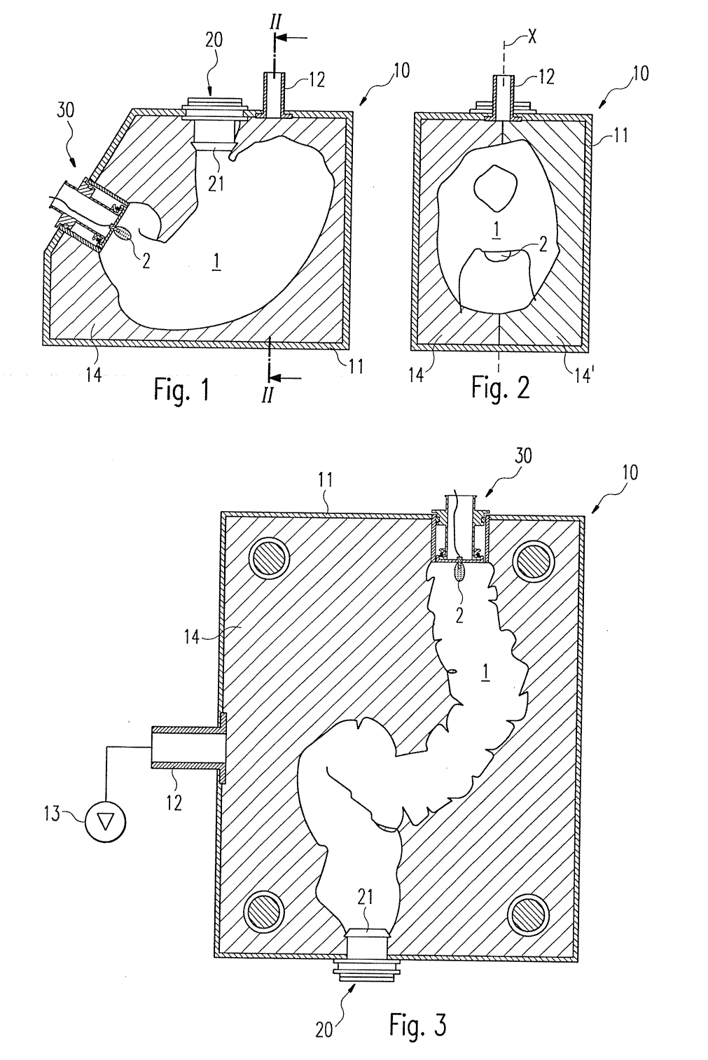

As FIG. 1 shows, a chamber 10 is provided comprising an air tight chamber wall 11. Traversing the chamber wall 11 there is a connection 12 which—as shown in FIG. 3—can be connected to a suction pump 13.

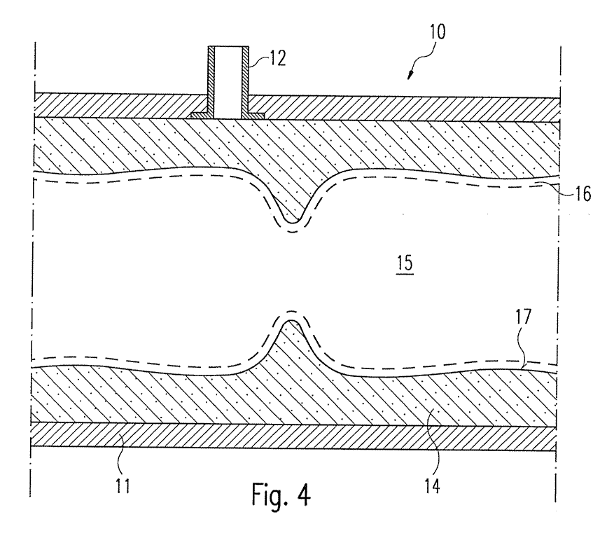

Inserted in the chamber 10 is a moulding which comprises two shells 14, 14′ (see FIG. 2). If the shells lie one on top of the other, the corresponding recesses of the moulding 14, 14′ form a cavity 15 (See FIG. 4), which, as shown in the figures, replicates a shape corresponding to the organ to be investigated, for example a stomach (FIGS. 1 and 2) or an intestine (FIG. 3).

In order to be able to insert an endoscope into the hollow organ 1, an inlet 20 is provided which leads into the hollow organ 1. This inlet 20 is explained below with reference to FIGS. 9 and 10.

The inlet 20 comprises a coupling device 21 in which the embodiment shown in FIGS. 9 and 10 is embodied as a shoulder over which an opening of the hollow organ 1 to be investigated or treated can be drawn. A tape or a rubber ring is then used to firmly connect the hollow organ 1 to the body of the inlet 20.

Provided at the side facing the hollow organ in use is a support device 22 which in the present case is an elastic rubber diaphragm with an opening 25 in the centre. This rubber diaphragm is secured by means of a fastening ring 24 on the sleeve 23 forming the main body of the inlet 20. On the introduction of an endoscope, the opening 25 widens slightly and hence provides the necessary hold for the endoscope.

If it is wished not only to perform training in how to handle an endoscope or training in diagnostic methods, in addition a quick-change device 30 is provided as shown in FIGS. 1-3. This quick-change device 30 is preferably embodied separate from the inlet 20, for example at another end of the inserted intestine or inserted stomach.

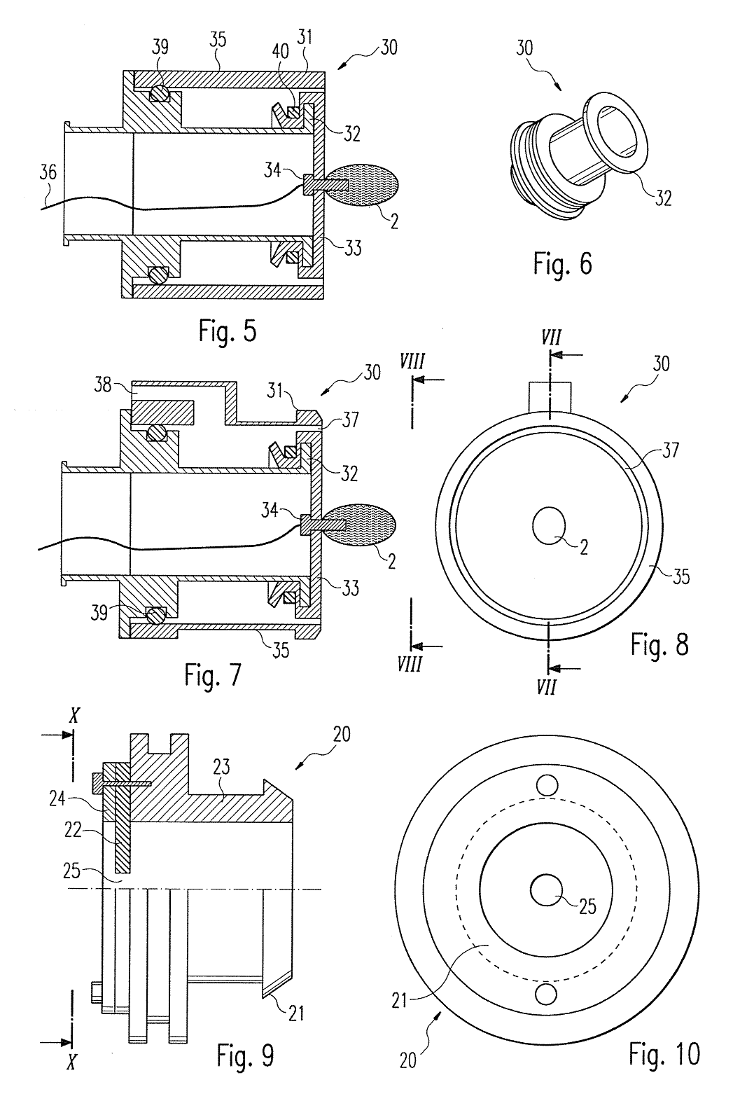

As shown in FIGS. 5 and 6, this quick-change device 30 comprises a connecting section 31 with which the quick-change device 30 can be connected to the hollow organ 1 in the same way as described above in the description of the inlet 20.

In addition, the quick-change device 30 comprises an interchangeable section 32 which is embodied with a sleeve-shape and is secured replaceably in a bushing 35 by means of an O-ring 39. The bushing 35 can be firmly connected, in particular tightly connected, to the wall 11 of the chamber 10.

In order to connect a treatment body 2, ie a piece of tissue, which is to be excised for example by HF-surgical methods, to the quick-change device, a diaphragm 33 is provided, which is fixed, for example via a rubber ring 40 on the interchangeable section 32. The treatment body 2 is secured on the diaphragm 33 by means of fastening means, for example a clip or a screw, or directly in the diaphragm so that, on the removal of the interchangeable section 32 from the bushing 35, either the treatment body 2 on its own or the treatment body 2 together with the diaphragm 33 can be quickly replaced. If this is to take place particularly quickly, it is of advantage to provide a plurality of interchangeable sections 32 of this kind with diaphragms 33 and treatment bodies 2 already affixed thereto.

The treatment body 2 can be connected by means of the fastening means 34 and a connection 36 to the neutral input of an electrosurgical device. This makes it possible to ensure that during the simulation of tissue excision, there is good contact between the electrosurgical device and the treatment body 2. A perspective view of the replaceable section 32 is shown in FIG. 6.

The embodiment of the quick-change device 30 shown in FIGS. 7 and 8 differs from that in FIGS. 5 and 6 in that additionally a device for the evacuation of smoke formed during the electrosurgical treatment of the treatment body 2 is provided. Naturally, this also applies when laser-surgery is used.

The smoke evacuation device comprises for example an annular gap 37 around the interchangeable section 32 with a diaphragm 33 affixed thereto, which opens out into a space connected to a suction pipe 38. The smoke evacuation device can also be integrated in the inlet part or elsewhere. This arrangement achieves very effective smoke evacuation close to the place of treatment.

In order to maintain the hollow organ 1 to be inserted in an as natural as possible condition, it is advantageous for the hollow organ 1 to be moistened. For this—as shown in FIG. 4—in the moulding 14, a wettable layer 16 is applied to a wall 17 of the cavity 15, which, with an introduced hollow organ and the evacuation of the air in the chamber 11, lies between the hollow organ and the cavity wall 17 on the porous moulding 14. Here, once again, it is possible to apply a neutral electrode, wherein then, for example, the cavity wall 17 and/or the layer 16 can be embodied as electrically conductive, which can be achieved by means of a corresponding salt content of the wetting liquid or also by the introduction of threads of a conductive material.

1. A training model for endoscopic investigations and treatment of hollow organs, comprising:
a substantially air-tight chamber for accommodating a hollow organ, the chamber having a chamber wall;
at least one inlet fastened in the chamber wall with a coupling device to which the hollow organ can be is coupled for introducing an endoscope through the inlet into the hollow organ;
a connection in the chamber wall to which can be coupled a suction pump for the generation of a negative pressure in the chamber; and
a moulding in the chamber comprising a cavity into which the coupling device opens out and which is adapted to an outer contour of the hollow organ and into which the hollow organ can be inserted.

2. The training model according to claim 1, further comprising
a quick-change device which includes a connecting for connecting the hollow organ to the quick-change device and an interchangeable section for the interchangeable mounting of a treatment body inside the hollow organ.

3. The training model according to claim 2,
wherein the quick-change device is attached traversing the chamber wall.

4. The training model according to claim 1,
wherein the moulding substantially fills the chamber.

5. The training model according to claim 1,
wherein the moulding is made of porous material.

6. The training model according to
wherein the moulding can be divided at least in sections along a centre plane leading through the cavity.

7. The training model according to claim 1,
wherein the inlet comprises a support device for supporting an endoscope to be inserted in the hollow organ.

8. The training model according to claim 7,
wherein the support device comprises an expandable opening with a smaller diameter than the hollow organ.

9. The training model according to claim 2,
wherein the quick-change device comprises a diaphragm to which the treatment body can be fixed.

10. The training model according to claim 2,
wherein the quick-change device comprises fastening means.

11. The training model according to claim 2,
wherein the quick-change device comprises an external bushing into which the interchangeable section can be inserted.

12. The training model according to claim 2,
wherein at least one of the quick-change device, the coupling device and the moulding is electrically conductive and is connected to a neutral electrode of a high-frequency surgical device.

13. The training model according to claim 1, further comprising
a wettable layer between the hollow organ and the moulding.

14. The training model according to claim 1, further comprising
a smoke evacuation device for the evacuation of smoke from the hollow organ.

15. The training model according to claim 1, wherein the moulding is made of foam.

16. The training model according to claim 8, wherein the expandable opening has a smaller diameter than the endoscope to be used.

17. The training model according to claim 9, wherein the diaphragm is interchangeable.

18. The training model according to claim 10, wherein the fastening means is one of a clip, a hook, a pointed bar and a screw.

19. The training model according to claim 11, wherein the interchangeable section can be inserted into the external bushing in a frictionally locking manner.

20. The training model according to claim 14, wherein the smoke evacuation device is attached to the coupling device.

21. The training model according to claim 2, further comprising a smoke evacuation device attached to the quick-change device for the evacuation of smoke from the hollow organ.
